(19) United States
(12) Patent Application Publication
(10) Pub. No.: US 2012/0320965 A1
(43) Pub. Date: Dec. 20, 2012

(54) APPARATUS AND METHOD FOR ENCODING/DECODING A MULTI-PLANE IMAGE, AND RECORDING MEDIUM FOR SAME

(75) Inventors: Sunyeon Kim, Seoul (KR); Jeongyeon Lim, Gyeonggi-do (KR); Gyumin Lee, Gyeonggi-do (KR); Jaehoon Choi, Gyeonggi-do (KR); Yoonsik Choe, Gyeonggi-do (KR); Yungho Choi, Gyeonggi-do (KR); Yonggoo Kim, Seoul (KR); Jinwoo Jeong, Seoul (KR)

(73) Assignee: SK TELECOM CO., LTD., Seoul (KR)

(21) Appl. No.: 13/514,563

(22) PCT Filed: Dec. 9, 2010
(86) PCT No.: PCT/KR10/08803

§ 371 Date: Aug. 22, 2012

(30) Foreign Application Priority Data
Dec. 9, 2009 (KR) 10-2009-0121964
Dec. 9, 2010 (KR) 10-2010-0125291

(51) Int. Cl. H04N 11/04

(52) U.S. Cl. 375/240.01; 375/E07.026

(57) ABSTRACT

The present disclosure relates to a multi-plane image encoding technology for adaptively determining the encoding sequence of planes in the image based on the characteristics of the image to be coded, and provides a multi-plane image encoding apparatus including a plane encoding sequence determiner for adaptively determining a sequence of multiple color planes inputted in a predetermined unit based on the encoding cost; and an encoder for encoding the multiple color planes inputted by the predetermined unit in the determined sequence. Encoding the multi-plane image with the sequence of the planes in the input image determined by the image characteristics enables an increased efficiency of encoding over conventional fixed plane sequence encoding, providing a particularly higher encoding efficiency when performing predictions between the planes.

### TECHNICAL FIELD

The present disclosure relates to video data encoding/decoding technology. More particularly, the present disclosure relates to an apparatus and a method for encoding/decoding a multi-plane video by adaptively determining a plane encoding sequence according to the characteristics of a video input, and a recording medium for the same.

### BACKGROUND

The statements in this section merely provide background information related to the present disclosure and may not constitute prior art.

In general, all color videos are input and output in RGB format. In other words, all colors may be expressed with colors of Red (R), Green (B), and Blue (B). However, the RGB format has such a high correlation between respective color channels that the compression ratio is disadvantageously low when a video is encoded in the RGB format. Accordingly, commercial applications currently use a video format of YCbCr format, instead of the RGB format, in processes of storage, transmission, and compression of a video. A method of converting the RGB format into the YCbCr format is defined by an international standard group, such as the International Telecommunication Union (ITU) or the Society of Motion Picture and Television Engineers (SMPTE). In the YCbCr, Y refers to a luminance component and Cb and Cr refer to chrominance components, and the correlation between respective color channels is substantially removed.

Most commercial applications currently use a signal in the 4:2:0 format, as well as a signal simply converted to the YCbCr format. FIG. 1 is a diagram illustrating the YCbCr 4:4:4 format, FIG. 2 is a diagram illustrating the YCbCr 4:4:2 format, and FIG. 3 is a diagram illustrating the YCbCr 4:2:0 format. According to the YCbCr 4:2:0 format, information on chrominance signals, i.e. Cb and Cr, is transversely and longitudinally sub-sampled by ½, so that the information on the chrominance signals is decreased to ¼ as illustrated in FIG. 3. This follows the principle that a person is more sensitive to a luminescence signal than a chrominance signal. Accordingly, most of the current video codecs including the MPEG-2/4, H.263, and H.264/MPEG-4 AVC basically encode and decode an input video in the YCbCr 4:2:0 format.

However, in this case, the chrominance signal of an encoded image experiences a big loss when compared to an original image. Accordingly, the professional application field, such as a digital cinema, a medical image, and an Ultra High Definition Television (UHDTV), uses the RGB 4:4:4 format or the YCbCr 4:4:4 format, rather than the YCbCr 4:2:0 format.

In order to support the format, the H.264/AVC AMD supports a signal processing in an RGB domain with high 4:4:4 intra/predictive profiles in the following two methods. The first method is a common mode method of commonly applying an intra/inter mode which has been determined at the time of encoding a green chrominance signal, to the encoding of a blue chrominance signal and a red chrominance signal in the processing of an RGB signal. The second method is an independent mode method of independently processing each of the R, G, and B signals. However, in this case, the compression ratio of an encoded image may be deteriorated due to the high correlation between the R, G and B signals as described above.

Accordingly, the high correlation between chrominance signals is inherent in the RGB domain, so that a research for improving the efficiency of an encoder through the removal of the correlation has been conducted.
[Document 1] Byung Cheol Song, Yun Gu Lee, and Nak Hoon Kim “Block Adaptive Inter-Color Compensation Algorithm for RGB 4:4:4 Video Coding,” IEEE CVST., vol. 18, no. 10, pp. 1447-1451, Oct., 2008.
[Document 2] Y.-H. Kim, S.-Y. Jung, B. H. Choi and J. K. Park, “High Fidelity RGB Video coding Using Adaptive Inter-Plane Weighted Prediction,” IEEE CVST., vol. 19, No. 7, pp 1051-1056, July, 2009.

In Document 1, based on the observation that the linear relationship is inherent between the R, G, and B signals, the R and B signals were predicted by using the G signal. In Document 2, the linear relation between R, G, and B signals was used to predict one color plane from another color plane.

Meanwhile, as Document 1 encodes a G plane which is then used exclusively to predict an R plane and a B plane, Document 2 first encodes a G plane followed by predicting a B plane from the G plane, and finally performs an encoding of an R plane with the B or G plane.

However, according to the aforementioned conventional technologies, the predictions are preformed only in designated sequence due to the fixed order of encoding/decoding among the planes, so that the prediction efficiency is deteriorated.

### DISCLOSURE

### Technical Problem

To solve the above-mentioned problems and meet the need for a developed technology, the present disclosure seeks to provide an apparatus and a method for encoding/decoding a multi-plane video by adaptively determining the encoding sequence between planes according to the characteristics of a video input, and a recording medium for the same, thereby improving the encoding and decoding efficiency.

### SUMMARY

An embodiment of the present disclosure provides an apparatus for encoding a multi-plane video including: a plane encoding sequence determiner for adaptively determining a sequence of multiple color planes inputted in a predetermined unit, based on an encoding cost; and an encoder for encoding the multiple color planes inputted by predetermined unit in a determined sequence. The plane encoding sequence determiner may set up all possible number of sequences of the multiple color planes inputted by predetermined unit, encode the multiple color planes in determined sequences respectively, and then determine an optimal sequence among the determined sequences based on the encoding cost. The encoding cost may be obtained based on a rate distortion optimization method. The encoder may perform the encoding on a first color plane in the determined sequence based on an intra plane prediction, and perform the encoding on a second and later color planes based on an inter plane prediction.

Another embodiment of the present disclosure provides a method for encoding a multi-plane video including: determining a plane encoding sequence by adaptively determining a sequence of multiple color planes inputted by predetermined unit, based on an encoding cost; and encoding the multiple color planes inputted by the predetermined unit by determined sequence, wherein the process of determining a plane encoding sequence may include: setting up all possible number of sequences of the multiple color planes inputted by predetermined unit; encoding the multiple color planes in determined sequences respectively, and determining an optimal sequence among the set sequences based on the encoding cost. The encoding cost may be obtained based on a rate distortion optimization method. The process of encoding may include: performing the encoding on a first color plane in the determined sequence based on an intra plane prediction; and performing the encoding on a second and later color planes in the determined sequence based on an inter plane prediction.

A further embodiment of the present disclosure provides a non-transitory computer readable recording medium for recording a computer program for causing, when executed in a processor, the processor to perform the method of encoding the multi-plane video.

A still further embodiment of the present disclosure provides an apparatus for decoding a multi-plane video including: a plane decoding sequence identifier for confirming a sequence of multiple color planes inputted in a predetermined unit from a bitstream; and a decoder for decoding the multiple color planes inputted by predetermined unit in a determined sequence.

A still yet further embodiment of the present disclosure provides a method for decoding a multi-plane video including: identifying a plane decoding sequence by confirming a sequence of multiple color planes inputted in a predetermined unit from a bitstream; and decoding the multiple color planes inputted by predetermined unit in a determined sequence.

The process of identifying the sequence of the multiple color planes may confirm the sequence of a blue plane, a red plane and a green plane by using color_plane_id in the bitstream.

A still further embodiment of the present disclosure provides a non-transitory computer readable recording medium for recording a computer program for causing, when executed in a processor, the processor to perform the method of decoding the multi-plane video.

### Advantageous Effects

According to various aspects of the present disclosure as described above, since the present disclosure reflects the characteristics of a multi-plane video in its encoding/decoding process by adaptively determining the encoding/decoding sequence between the planes, and thereby providing a higher encoding and decoding efficiency over the conventional fixed sequence plane encoding and decoding, and in particular a higher encoding/decoding efficiency in performing predictions between the planes.

### DESCRIPTION OF DRAWINGS

FIGS. 1 to 3 are diagrams illustrating the YCbCr 4:4:4 format, the YCbCr 4:4:2 format, and the YCbCr 4:2:0 format, respectively;

FIG. 4 is a block diagram illustrating a multi-plane video encoding apparatus according to an embodiment of the present;

FIG. 5 is a detailed block diagram of a plane encoding sequence determiner of FIG. 4;

FIG. 6 is a block diagram for schematically illustrating a multi-plane video decoding apparatus according to an embodiment of the present disclosure;

FIG. 7 is a flowchart illustrating a multi-plane video encoding method according to an embodiment of the present disclosure;

FIG. 8 is a detailed flowchart of a process of determining plane encoding sequence of FIG. 7; and

FIG. 9 is a flowchart illustrating a multi-plane video decoding method according to an embodiment of the present disclosure.

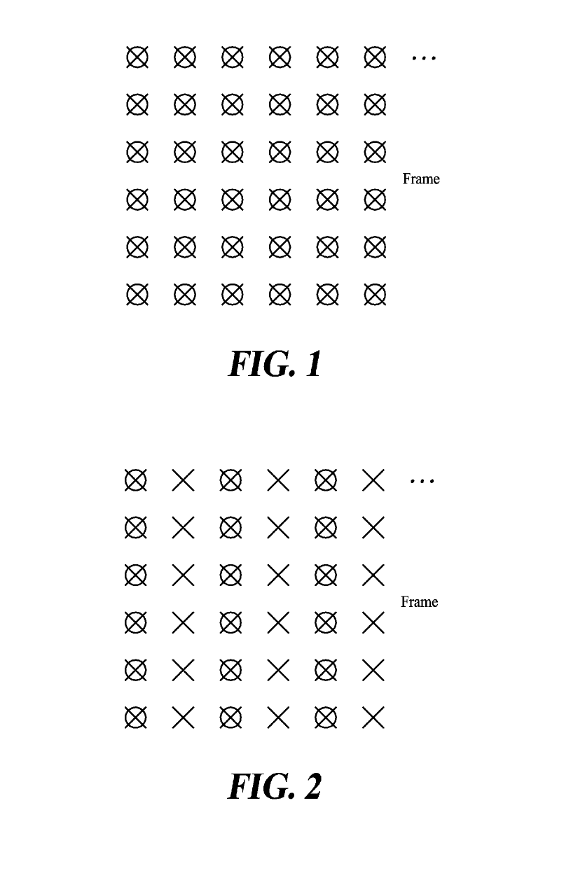

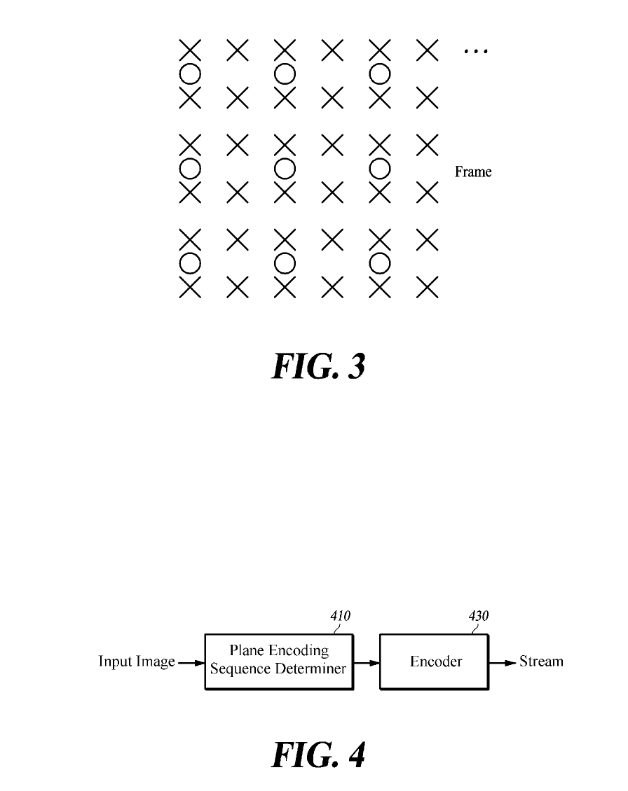

### DETAILED DESCRIPTION

Hereinafter, an apparatus and a method for encoding/decoding a multi-plane video and a recording medium for the same according to embodiments of the present disclosure will be described in detail with reference to the accompanying drawings.

FIG. 4 is a block diagram illustrating a multi-plane video encoding apparatus according to an embodiment of the present disclosure, which includes a plane encoding sequence determiner 410 and an encoder 430.

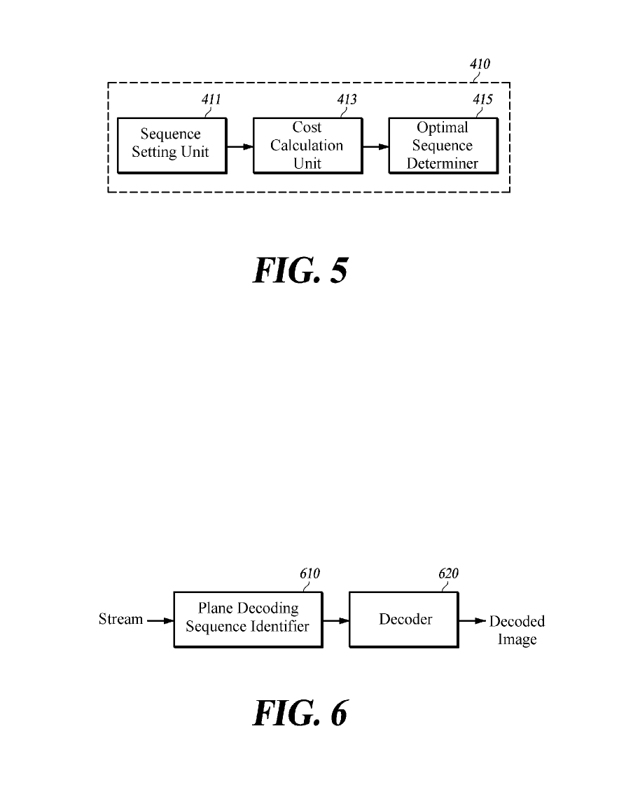

The plane encoding sequence determiner 410 is configured to adaptively determine the sequence of color planes inputted in predetermined units to encode based on the encoding cost of the planes. It includes a sequence setting unit 411 for setting up all the possible number of cases of sequences of multiple color planes inputted in a predetermined unit, a cost calculation unit 413 for encoding the multiple color planes in each of the set sequences and then finding the cost in that encoding, and an optimal sequence determiner 415 for determining an optimal sequence among the respective sequences based on the calculated costs, as illustrated in FIG. 5. According to an embodiment of the present invention, the costs may be calculated based on the rate distortion optimization method. The multiple color planes as the input image includes at least a green plane, a blue plane and a red plane. Moreover, according to an embodiment of the present invention, the input image may be inputted for processing by certain unit of the sequence, frame, slice, macroblock or block, etc.

Encoder 430 is configured to encode the multiple planes in the sequence determined by plane encoding sequence determiner 410, wherein the first color plane in the determined sequence may undergo encoding based on an intra plane prediction, and the second and later planes may undergo encoding based on an inter plane prediction, according to this embodiment.

The present disclosure may be applied not only to the independent encoding method of independently encoding the color plane by plane but also to the common encoding method that uses a common prediction mode among the color planes.

FIG. 6 is a block diagram for schematically illustrating a multi-plane video decoding apparatus according to an embodiment of the present disclosure. As illustrated in FIG. 6, the multi-plane video encoding apparatus 600 of an embodiment may include a plane decoding sequence identifier 610 and a decoder 620.

Plane decoding sequence identifier 610 confirms the color plane to be currently decoded by identifying color_plane_id in a video stream.

Decoder 620 performs decoding on the first color plane in the determined sequence based on an intra plane prediction and on the second and later planes based on an inter plane prediction.

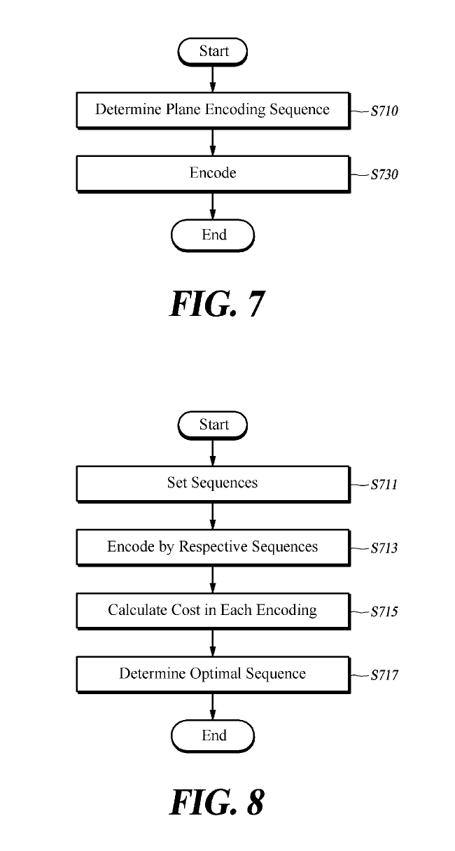

FIG. 7 is a flowchart illustrating a multi-plane video encoding method according to an embodiment of the present disclosure. As illustrated, the method includes a plane encoding sequence determining process S710 and an encoding process S730, and is applicable for an example to the multi-plane video encoding apparatus of FIG. 4, and thus the method and apparatus will be described together.

Plane Encoding Sequence Determining Process S710

At first, upon receiving an image signal by unit of the frame, slice, macroblock, block, etc., plane encoding sequence determiner 410 adaptively determines the sequence between the multiple planes as an input image based on their encoding costs.

FIG. 8 is a detailed flowchart of a plane encoding sequence determining process S710 of FIG. 7 for illustrating a process S710 of initially setting sequences of a number of color planes in a predetermined input unit by all the possible number of cases, a process S713 of encoding the multiple color planes in each of the set sequences, a process S715 of calculating the cost for each encoding at process S713, and a process S717 of determining a lowest cost sequence as an optimal sequence among the entire sequences set in process S711.

Encoding Process S730

Encoder 430 in this process carries out encoding on the number of color planes input in the predetermined input unit in the optimal sequence which is determined adaptively by plane encoding sequence determiner 410 in plane encoding sequence determining process S710. Encoder 430 in this process carries out encoding on the first color plane in the determined sequence based on the intra plane prediction, and on the second and later planes in the determined sequence based on the inter plane prediction.

Hereinafter, an operation/effect of the apparatus of FIG. 4 and a detailed process of the method of FIG. 5 corresponding thereto will be described in detail.

According to the embodiment of the present disclosure, plane encoding sequence determiner 410 or plane encoding sequence determining process S710 determines the encoding sequence of the respective planes. The same plane encoding sequence determiner 410 or plane encoding sequence determining process S710 determines an optimal sequence in a method as will be exemplified below. For example, the input image is assumably composed of three kinds of R, G, B planes. In addition, encoder 430 or encoding process S730 carries out predictions between the planes in a method as will be described below. The inter plane prediction refers to process of performing predictions between planes for the purpose of improving the encoding efficiency. The first green plane is allowed to skip the inter plane prediction but encoded by using its own plane information, which is called the intra plane prediction. The second blue plane has the inter plane prediction performed by using the encoded information of the first plane. With the single available counterpart of the first encoded plane to employ, the second plane may have the inter plane prediction performed therein. With the first and/or second planes available for use, the third red plane has the inter plane prediction performed therein. In this event, there is a need to store information on whether the current block has the inter plane prediction performed in the first plane or the second plane and to transmit the information toward a decoder.

The following description will be provided on the premise that encoder 430 and encoding process S730 operate as mentioned above. Although the illustrated structures of encoder 430 and encoding process S730 are expected to maximize the performance of the disclosure, encoder 430 and encoding process S730 are not limited to the aforementioned case.

For the convenience of description of plane encoding sequence determiner 410 and plane encoding sequence determining process S710, it is assumed that the green plane is named the first plane and has been already encoded. Then, the remainders are the blue and red planes. Conventional method would perform encoding on the second plane as designated by the blue plane and the third plane as designated by the red plane. However, in accordance with the present disclosure, the secondly encoded plane may be either the blue plane or the red plane following the characteristics of the image.

Decision of the plane sequence in plane encoding sequence determiner 410 and plane encoding sequence determining process S710 may be made by the rate distortion optimization (RDO) among other techniques may be used unlimitedly for the purpose of the present disclosure. In this embodiment, the input image may be in units of the sequence, frame, slice, macroblock, block, etc.

In plane encoding sequence determiner 410 and plane encoding sequence determining process S710, the RDO-based plane encoding sequencing technique is as follows. Equation 1 below represents the cost when the blue plane is encoded followed by the red plane with the green plane encoded already as the first plane. In Equation 1, R represents the bits generated by encoding the blue plane image and the red plane image when encoder 430 performed encoding in the sequence of the green, blue and then red, D represents a distortion from the original image, of a decoded image generated by decoding performed with encoded bits, and λ is Lagrange multipliers having constant values. Equation 2 means a cost generated when the green plane is first encoded, encoding the red plane next followed by encoding the blue plane.

J_{B,R|G}=D_{B,R|G}+λR_{B,R|G} Equation 1

J_{R,B|G}=D_{R,B|G}+λR_{R,B|G} Equation 2

Between Equation 1 and Equation 2, the lowest cost generated makes up the optimal encoding plane sequence of the subject image. In other words, if Equation 2 is smaller than Equation 1, the second plane may be determined to be the red plane, and the third plane may become the blue plane.

In this way, plane encoding sequence determiner 410 and plane encoding sequence determining process S710 may operate based on RDO to determine the plane encoding sequence by predetermined units of an image. The first plane is not necessarily predetermined with the green plane as above, but the RDO-based plane encoding sequencing technique may apply to the first plane from the outset.

Encoder 430 or encoding process S730 performs encoding following the optimal plane sequence outputted from the plane encoding sequence determiner 410 or plane encoding sequence determining process S710. Specifically, if the optimal sequence is the green, red and then blue, encoder 430 or encoding process S730 performs encoding on the green plane first, performs encoding on the red plane second by using an inter plane prediction with respect to the green plane, and eventually on the blue plane through an inter plane prediction with a selection of the higher encoding efficiency plane between the red and green planes.

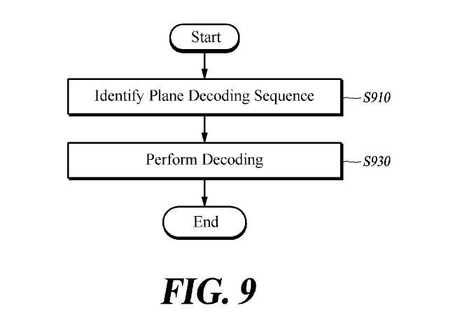

FIG. 9 is a flowchart illustrating a multi-plane video decoding method according to an embodiment of the present disclosure. As illustrated, the multi-plane video decoding method includes a plane encoding sequence confirming process S910 and a decoding process S930.

Plane encoding sequence confirming process S910 confirms color information of a current plane by using color_plane_id in a bitstream. For example, between color_plane_id and the color plane there may be mapping provided as in Table 1.

TABLE 1

| Color_plane_id | Color |
|---|---|
| 0 | Green |
| 1 | Blue |
| 2 | Red |

For example, if the encoded color_plane_id in the bitstream 1,2,0, then a blue plane may be first encoded, encoding a red plane next followed by encoding a blue plane.

Decoding process S930 performs decoding based on the color plane decoding sequence. In this example, if the encoding sequence is the blue, red and green planes, the blue plane is first decoded by using an intra plane prediction, the red plane is decoded next through either an intra plane prediction or the blue plane based inter plane prediction, and the green plane is decoded through an intra plane predicting or an inter plane prediction using the blue and red planes.

In a common mode where a common prediction mode is used for the RGB signals, it is recommended to add the sequence of color_plane_id to the header of the stream, which may be done in a method described below. There are six possible decoding sequences of the RGB color planes. For example, codeword for this operation may be encoded into fixed codeword, which does not restrict the present disclosure from utilizing other schemes.

TABLE 2

| Color_plane_id_order | Codeword |
|---|---|
| 0, 1, 2 | 000 |
| 0, 2, 1 | 001 |
| 1, 2, 0 | 010 |
| 1, 0, 2 | 011 |
| 2, 1, 0 | 100 |
| 2, 0, 1 | 101 |

The multi-plane video encoding method according to the embodiment of the present disclosure described with reference to FIGS. 7 and 8 and the multi-plane video decoding method according to the embodiment of the present disclosure described with reference to FIG. 9 may be implemented by a computer readable recording medium including program commands for performing various operations executed by a computer, respectively. The computer readable recording medium may include separate or a combination of program commands, a local data file, a local data structure, etc. The computer readable recording medium may be specially designed and configured for the embodiment of the present disclosure, or may be publicly known to and available to one skilled in a computer software field. An example of the computer readable recording medium includes a magnetic medium such as a hard disk, a floppy disk, and a magnetic disk, an optical recording medium such as CD-ROM and DVD, a magnetic-optical medium like a floptical disk, and a hardware device including ROM, RAM, and flash memory specially configured for storage and execution of program commands. The computer readable recording medium may be a transmission medium, such as optical or metal lines and a waveguide including a carrier for transmitting a signal designating a program command, a local data structure, etc. An example of the program command may include a high-level language code executable by a computer by using an interpreter, etc., as well as a machine code created by a complier.

Although exemplary embodiments of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful to apply in the fields of video data compression technology, especially, the multi-plane video encoding/decoding technology, to encoding/decoding operations by adaptively determining the encoding/decoding sequence among planes based on the input image characteristics to provide a higher encoding/decoding efficiency over the conventional fixed plane sequence encoding/decoding, and particularly higher encoding/decoding in carrying out predictions between the planes.

### CROSS-REFERENCE TO RELATED APPLICATION

If applicable, this application claims priorities under 35 U.S.C. §119(a) of Patent Application No. 10-2009-0121964, filed on Dec. 9, 2009 and Patent Application No. 10-2010-0125291, filed on Dec. 9, 2010 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. An apparatus for encoding a multi-plane video, comprising:
a plane encoding sequence determiner for adaptively determining a sequence of multiple color planes inputted in a predetermined unit, based on an encoding cost; and
an encoder for encoding the multiple color planes inputted by predetermined unit in a determined sequence.

2. The apparatus of claim 1, wherein the plane encoding sequence determiner sets up all possible number of sequences of the multiple color planes inputted by predetermined unit, encodes the multiple color planes in determined sequences respectively, and then determines an optimal sequence among the determined sequences based on the encoding cost.

3. The apparatus of claim 1, wherein the encoding cost is obtained based on a rate distortion optimization method.

4. The apparatus of claim 1, wherein the encoder performs the encoding on a first color plane in the determined sequence based on an intra plane prediction, and performs the encoding on a second and later color planes based on an inter plane prediction.

5. The apparatus of claim 1, wherein the multiple color planes include at least a green plane, a blue plane and a red plane.

6. A method for encoding a multi-plane video, comprising:
determining a plane encoding sequence by adaptively determining a sequence of multiple color planes inputted by predetermined unit, based on an encoding cost; and
encoding the multiple color planes inputted by the predetermined unit by determined sequence.

7. The method of claim 6, wherein the process of determining a plane encoding sequence comprises:
setting up all possible number of sequences of the multiple color planes inputted by predetermined unit;
encoding the multiple color planes in determined sequences respectively, and
determining an optimal sequence among the determined sequences based on the encoding cost.

8. The method of claim 6, wherein the encoding cost is obtained based on a rate distortion optimization method.

9. The method of claim 6, wherein the process of encoding comprises:
performing the encoding on a first color plane in the determined sequence based on an intra plane prediction; and
performing the encoding on a second and later color planes in the determined sequence based on an inter plane prediction.

10. The method of claim 6, wherein the multiple color planes include at least a green plane, a blue plane and a red plane.

11. A non-transitory computer readable recording medium for recording a computer program for causing, when executed in a processor, the processor to perform the method of encoding the multi-plane video of claim 6.

12. An apparatus for decoding a multi-plane video, comprising:
a plane decoding sequence identifier for confirming a sequence of multiple color planes inputted in a predetermined unit from a bitstream; and
a decoder for decoding the multiple color planes inputted by predetermined unit in a determined sequence.

13. A method for decoding a multi-plane video, comprising:
identifying a plane decoding sequence by confirming a sequence of multiple color planes inputted in a predetermined unit from a bitstream; and
decoding the multiple color planes inputted by predetermined unit in a determined sequence.

14. The method of claim 13, wherein the process of identifying the sequence of the multiple color planes confirms the sequence of a blue plane, a red plane and a green plane by using color_plane_id in the bitstream.

15. A non-transitory computer readable recording medium for recording a computer program for causing, when executed in a processor, the processor to perform the method of decoding the multi-plane video of claim 13.
